(19) United States
(12) Patent Application Publication
(10) Pub. No.: US 2003/0131743 A1
(43) Pub. Date: Jul. 17, 2003

(54) Roller with detachable roller cover

(76) Inventors: Alexander Sauer, Berlin (DE); Mathias Zisenis, Berlin (DE)

Correspondence Address: CONNOLLY BOVE LODGE & HUTZ LLP, 1220 Market Street, P.O. Box 2207, Wilmington, DE, 19899, US

(21) Appl. No.: 10/047,175

(22) Filed: Jan. 15, 2002

(51) Int. Cl. B41F 13/26; B41F 13/08

(52) U.S. Cl. 101/348; 101/375; 492/49

(57) ABSTRACT

Printing rollers, in particular ink rollers, dampening rollers or varnishing rollers for web-fed offset printing machines and sheet-fed offset printing machines, with a rigid roller core and a roller cover with an outside layer from elastomeric or elastic plastic material are constructed that way that the roller cover is connected with the roller core detachable. In this way for inking units, dampening units and varnishing units of printing machines rollers are made available, whose roller cover is exchangeable and can be used in a one-way method.

### FIELD OF THE INVENTION

The present invention is generally related to a roller with a rigid roller core and a detachable roller cover which is connected therewith, and to its use in offset printing machines. This essentially concerns rollers, whose core and cover are connected detachable with one another according to the principles of the sleeve technology. Such rollers are well-known in different types and for different applications in the printing technology.

### BACKGROUND

Most well-known applications for rollers developed according to the sleeve technology are printing cylinders for the rotogravure printing and for the flexographic printing. These rollers consist of a rigid essentially cylindrical roller core, occasionally also called roller base, and a properly matching detachable roller cover with multi-layer structure. With gravure cylinders the outside layer of the roller cover usually consists of a metallic material. This layer is usually connected with a tubular carrier body, which is metallic or formed out of a fiber reinforced composite material, by different elastic and flexible intermediate layers. With the flexographic printing a similar structure is known wherein the outside layer usually consists of a plastic.

In DE-195 45 597-A1, for example, a sleeve for printing rollers or screen rollers is described, which comprises an internal tube from an expandable plastic material and an exterior metallic tube, whose surface is covered with an engravable or for the flexographic printing suitable layer, wherein the space between the tubes is filled out with a foam material. A printing roller from a light metal-alloy or steel, or a printing roller sleeve from fiber reinforced composite material such as GRP (glass-fiber reinforced plastic) and CRP (carbon-fiber reinforced plastic) or a metallic material such as nickel for the flexographic printing with a seamless covering from polyurethane (PU) having a thickness of at least 3 mm and a hardness of from 30 to 60 shores A, whose surface is provided with continuous, positive or negative printing forms by means of laser engraving, is disclosed in DE-199 44 136-A1.

The development of the sleeve technology in the rotogravure and flexographic printing is based essentially on the fact that for the continuous stationery printing on webs printing plates from engravable materials had to be applied onto printing cylinders exchangeable. The possibility of forming exchangeable covers for rollers by use of the sleeve technology was recognized, however, also in other areas. Thus U.S. Pat. No. 3,639,959 describes rubber covers for transport rollers on a rigid conical inner sleeve from glass-fiber reinforced synthetic resin, which serve as exchangeable item of equipment in connection with likewise conical formed reel cores.

DE-25 14 294-C2 discloses rollers for the print treatment of webs, e.g. gravure rollers, with ready to mount covers. These rollers consist of a rigid cylindrical roller core and a detachable applied cover of rubber or rubber-like plastics with an reinforcement insert, of textile threads or steel wire for example, and a conical angle of from a few minutes to maximally 1° of the interior cover surface. The worn out elastomeric roller cover can be removed on the spot and be returned for itself for renewing, while the associated roller core remains in the plant.

A roller with a cylindrical roller core and a cylindrical cover from an adhesive rubber layer upon the roller core, a fabric layer placed thereon and an outside working layer on the latter is described in DE-31 39 494-C2. The layers of the cover are bond to each other by vulcanization. The inside diameter of the cover is a little smaller than the outside diameter of the roller core, which is provided with a compressed air mechanism for producing a compressed air layer to facilitate pushing the cover onto the roller core.

The entering of the sleeve technology into the art of offset printing machines working with rubber impression cylinders is limited so far to ink rollers for the double-page printing and to printing cylinders. Exchangeable rubber-covered sleeves for print unit cylinders, i.e. offset cylinders, plate cylinders and impression cylinders, as well as a device for applying the sleeve using the compressed air technique within the printing machine are disclosed, for example, in EP-277,545-A2. EP-704,301-B1 describes a printing roller for the gap-less printing having a roller core and a tube-shaped printing or transfer form, attachable by use of compressed air, with an additional intermediate layer, for example from self adhesive plastic foil, for the adjustment. With ink rollers for the double-page printing parts of the cover are formed tubular and arranged axially adjustable and/or rotating and, sliding on the roller core over roller bearings (DE-196 28 647-A1, DE-296 09 007-U1).

Usually also nowadays rollers in the inking units, dampening units and varnishing units of offset printing machines are still exchanged for new rollers after wear, and de-installed completely and sent to the roller supplier for reconditioning or recovering in this connection. Since always printing rollers have to be available in the printhouse for the exchange of rollers being in the machine, and usually one set of rollers or more is with the roller manufacturer, this brings about that a multiplicity of roller cores must be procured and provided with stock. In particular with complex designed or arranged rollers like oscillating rollers or rollers provided with means for keeping at a special temperature, this is quite expensive. Adding to this, particularly with larger and thus quite heavy rollers, is the increased expenditure of work, which is connected with the exchange of the complete rollers on the part of the printhouse and with the transport for collection and delivery of the rollers and with the handling of the rollers during fabrication on the part of the roller manufacturer.

### THE INVENTION

On this background the task existed to provide printing rollers for the offset printing whose use and handling are clearly improved with respect to present economic criteria. This task is solved by the fact that printing rollers applicable according to the sleeve technology are made available for offset printing machines.

The object of the invention thus is a roller having a rigid roller core and a roller cover being connected detachable therewith, characterized in that the roller cover comprises an outside layer from elastomeric or elastic plastic material and that the roller is a printing roller, in particular an ink roller, a dampening roller or a varnishing roller for a web-fed or a sheet-fed offset printing machine, on the one hand, and, on the other hand, an inking unit, dampening unit or varnishing unit of a printing machine, in particular of a web-fed or sheet-fed offset printing machine, characterized by the fact that it comprises at least one roller in accordance with the invention.

The invention thus also relates to the use of a roller with a rigid roller core and a roller cover with an outside layer from elastomeric or elastic plastic material connected detachable therewith as a printing roller, in particular as ink roller, dampening roller or varnishing roller in a web-fed or sheet-fed offset printing machine, as well as a process for the exchange of the roller cover of a printing roller having a rigid roller core and a roller cover with an outside layer from elastomeric or elastic plastic material, in particular of an ink, dampening or varnishing roller in a web-fed or sheet-fed offset printing machine, characterized by the fact that the roller cover is connected detachable with the roller core.

Even before the long-lasting well-known state of the art already quoted concerning the use of the sleeve technology with rollers, it was not at all obvious to realize this technology also for ink rollers, dampening rollers and varnishing rollers in offset printing machines. Against this realization both emotional/psychological reasons, for example the traditional trading way between printhouses and roller manufacturers, and several technical reasons spoke. To be exact, ink units, dampening units and varnishing units in offset printing machines, depending upon the construction and configuration of the print unit, usually comprise a plurality of rollers which are called, according to their respective function, for example pan roller, fountain roller, ductor roller, transfer roller, distributor roller or form roller and which are also present repeatedly in part. Changing from manufacturer to manufacturer, from one type of a machine to another, and often also within one type of a machine as well as within one ink, dampening or varnishing unit, these rollers have different dimensions. This requires that the manufacturing of exchangeable roller covers enables a high flexibility and variability. Up to date, this flexibility as well as the costs connected with the remodeling of the printing machines are regarded as too expensive and uneconomically.

Despite this so far economically negative opinion an economic advantage is seen in the disposition of printing rollers, in particular of ink rollers, dampening rollers or varnishing rollers for web-fed and sheet-fed offset printing machines, having a rigid roller core and a roller cover connected detachable therewith. On a long-term basis, costs for procuring are more favorable for the printhouse, the handling of the rollers within the printing plant becomes easier through the lighter tube-like roller covers, and on the part of the roller manufacturer the handling becomes easier, in particular if the roller covers can be deposited economically and exchanged against roller covers fresh from the factory, instead of laboriously being transported, stored temporarily, and regenerated or re-covered. Thus, printing rollers are made available by the invention for the first time for offset printing machines, whose roller covers can be used one-way.

A further technical problem which is to be considered with the application of the sleeve technology to printing rollers in offset printing machines and whose missing solution prevented this application so far, is the often high mechanical and dynamic load of these rollers during operation. A perfect tight hold of the cover sleeve on the roller core as well as a high inherent stability of the roller cover in itself during the operation and service life of the roller are indispensable for the printer. Further embodiments of the printing roller according to invention, which are described in the following as well as in the examples and dependent claims, are related to solutions of this special problem.

### DETAILED DESCRIPTION OF THE INVENTION

The roller core of the printing roller according to the invention consists of a roller base with an essentially cylindrical lateral surface which comprises mechanisms at its faces for the admission of the roller into the printing machine, for example bearing journals or roller bearings for the take up of the roller on a shaft. If the roller takes a certain function in the printing machine, then the roller core can be modified accordingly. This includes, for example, oscillating rollers, which have a mechanism for the axial movement of the roller, as well as rollers having canals through which a medium serving for keeping at a moderate temperature can be led.

The base of the roller core can be formed as solid body, frequently however, in particular with rollers of medium (diameter 30 to 250 mm) and larger dimensions (diameters>250 mm), the roller base is shaped tubular to save moving mass or manufacturing costs. To reinforce the tubular bases these can comprise for instance supporting disks, back-up rings, bracings, lattices or networks. The roller core, in particular its base, may consist of a metallic material an oxide-ceramic, metal-ceramic, glass-ceramic or polymer-ceramic material, a polymer-bound mineral casting (also known as reaction resin concrete or concrete polymer composite) or of a plastic material. Plastic materials are preferably reinforced with fibers or other particles in order to ensure a sufficient form stability and dimensional stability. Optionally, the surface of the roller core can be treated chemically or physically, i.e. be provided totally or partly with a metallic layer for example. That way the impact resistance and the resistance to abrasion of the surface can be increased or the optical impression of the roller core be improved. Methods for the surface treatment are well-known in different technical fields and can be transferred for the production of the roller according to invention.

The roller base can be provided with openings at its lateral surface and, optionally, also at a properly formed face. Providing the roller core with compressed air, air passes through these openings and forms an air layer on which the roller cover can be moved. In principle, the expert is familiar with this principle and the respective technology. The roller base can also be formed such that its diameter is variable. Possible embodiments of such roller cores are described in EP-970,807-A1 for example.

The lateral surface of the roller base essentially is arranged cylindrical or slightly conical. The conical angle hereby favorably is of from a few minutes to 1°, preferably it is less than 0.50. In addition, the lateral surface may comprise recesses and/or raises in which appropriately formed raises and/or recesses at the inner surface of the roller cover can lock in. These raises and recesses serve to stabilize the hold of the roller cover on the roller core (=‘anchorage’ of the roller cover) and thus also to ensure the running of the printing roller under high mechanical or dynamic load. On the other hand, these raises and recesses are formed in such a way that the locked roller cover can be loosened from the roller core under mechanical impact and/or through the formation of a compressed air layer. For this it can be favorable to form the edges of the raises and/or recesses less steep in axial direction of the roller than in radial direction as well as to round the edges off.

The lateral surface of the roller base can have one or more recesses in the form of grooves axially, for instance over its entire length or in sub-ranges. Into these grooves preferably bar-like raises situated at the inner surface of the roller covers reach and thus ensure a firm hold of the roller cover on the roller core in the direction of rotation. The lateral surface of the roller base can also have one or more recesses in the form of continuous or interrupted grooves, in which appropriately formed raises at the inner surface of the roller covers interlock, radially. Thereby for instance an anchorage of the roller cover in axial direction can take place. Groove-like recesses can be arranged also on spiral lines, such that the roller cover is put on the roller core by a screwing movement. Favorably the screwing direction is oriented against the rotation direction of the roller during the print operation. The lateral surface of the roller core may also punctually have one or more suitable formed recesses in which corresponding raises at the inner surface of the roller cover can interlock. Similar to these examples in reverse also raises can be present at the lateral surface of the roller base and recesses at the inner surface of the roller cover.

The roller base can be provided also with one or more electromagnetic devices, particularly at its lateral surface. At release, for instance, these can cause a magnetic adhesion to counter poles present at or in the roller cover, and thus fix the roller cover with the roller core. In principle, the roller cover as well can be provided with an electromagnetic device which arrests magnetically with counter poles at the roller core. Preferably, the electromagnetic device is placed at the roller core.

The roller cover may consist entirely of a covering of elastomeric or elastic plastic or be formed by a carrier body provided with a covering. This carrier body can be present in form of a tube from a metallic, oxide-ceramic, metal-ceramic, glass-ceramic or polymer-ceramic material or from a plastic material. For example, the carrier body can be represented by a thin tube out of aluminum, nickel or steel, or out of an alumina-ceramic, or by a tube out of a fiber reinforced composite material. The latter is known in principle, particularly from the rotogravure and flexographic printing technologies, and commercially available in various types. Such tubes consist of an epoxy or polyester resin reinforced with glass-fibers (GRP), carbon-fibers (CRP) or aramide-fibers, for example, but they can also consist of other temperature-steady engineering plastics. The fibers can be both short fibers and long fibers (length of the single fiber >0.4 mm) as well as continuous fibers.

Since, according to the invention, the roller covers are drawn up on solid roller cores, they do not have to fulfill the high mechanical standards as are set for self-supporting tube-like carrier bodies or roller covers. Compared to these, the layer thickness of the carrier bodies can be reduced significantly, for example to half or less than half of the thickness of a self-supporting carrier body of the same dimension. Due to its higher rigidity in comparison to a covering, the advantage of a roller cover provided with a carrier body essentially consists in decreasing the friction forces arising when assembling and disassembling the roller cover as well as in ensuring a safe properly matching hold of the roller cover on the roller core. For the decrease of friction forces it is particularly advantageous to use sliding and friction modified plastics or to provide at least the exterior of the inner surface area of the roller cover with a coating having very good sliding and friction properties.

Roller covers which do not possess a rigid carrier body can be reinforced, particularly within the area of the cover inner surface, by reinforcing inserts such as fabrics, networks or fleeces from textile threads. This way the firm hold of the roller cover on the roller core can be assured for its service time as well. Whether a roller cover is equipped with reinforcement or not, and/or with a carrier body or not depends on the operational standards set for the respective printing roller. For a low mechanical load of the roller, the roller cover may consist exclusively of the covering material, at a particular high mechanical and dynamic load of the roller due to milling at high speeds of rotation or high impression pressures the roller cover preferably is provided with a rigid carrier body.

Roller covers comprising a carrier body or a reinforcement also keep their shape problem-free during their storage in-between the manufacturing at the roller company and their use in the printhouse. Roller covers without a carrier body or reinforcement favorably are provided with a supporting spike during the storage. For economic and ecological reasons recycling material made of plastic or pasteboard is used for this preferably.

As additional or alternative mechanism for stabilizing the connection between roller core and roller cover, in particular during the printing process, raises or recesses can be provided at the faces of the roller cover which mesh with corresponding recesses or raises formed at the roller core and thus fix the roller cover in radial and axial direction. With rollers having a carrier body these raises and recesses are preferably formed by spaces in the carrier body. Generally the roller covers are formed in a way that the raises and recesses at the faces do not effect negatively the printed image while printing or the distribution of the liquid media. Preferably, therefore the covering of the roller cover is cylindrical at its lateral surface and has no structuring at the front surfaces.

The covering of the roller covers may comprise cuts, shapings, textures or aggravations, however, if necessary. For example, the surface of the roller cover can be divided into two, three or more ranges by cuts. In this way, for instance, exchangeable roller covers can be provided for the double-page printing.

Optionally the roller cover can be built-up by one or more layers. This concerns both the structure of the carrier body and of the covering, which is connected with a carrier body by a suitable bonding agent if necessary. As elastomeric or elastic plastic material for the roller covering according to the invention elastomers or elastic plastics, i.e. vulcanized rubbers such as natural rubber (NR) or synthetic rubber, e.g. acrylonitrile butadiene rubber (NBR, HNBR, XNBR), ethylene rubber (CM, CSM), ethylene propylene rubber (EPM, EPDM), styrene butadiene rubber (SBR, XSBR), butyl rubber (IIR), polyisoprene rubber (IR), ester and ether polyurethane rubber (AU, EU), polyacrylic rubber (ACM), ethylene acrylic rubber (EAM), epichlorohydrine rubber (CO, ECO, ETER), polynorbomene rubber (PNR), silicone rubber (MQ, MFQ, MPQ, MVQ, WVQ), fluorocarbon rubber (FKM) or chloroprene rubber (CR), elastic thermoplastics, e.g. polyvinyl chloride (PVC) or elasticized polyolefin (e.g. PP-EPDM), thermoplastic elastomer (TPE), e.g. styrene block copolymer (SBS, SEBS, SIS), co-polyester elastomer or thermoplastic polyurethane (TPU), castable or foamable plastics, particularly such on basis of polyurethane, or mixtures of the components mentioned can be used as basis. The material is to be selected and modified according to the targeted application and the function of the respective roller.

Additionally, the elastomeric or elastic plastic material may comprise usual additives, in particular fillers, coloring agents, reinforcing materials, softener and/or fibrous material as well as further functional additives, for example substances for adjusting the hydrophilic or hydrophobic properties of the roller surface or ink-repellent substances like fluorinated polyolefin (e.g. Teflon). These can be admixed to the plastic material of the covering or—in the case of the functional additives—bond to the plastic material by chemical reaction or polymerization. Optionally, the covering can also be covered with a thin tube from a thermoplastic plastic, e.g. from Teflon hose, or become covered or wrapped with textile materials, e.g. rubber-soaked fleeces.

At the production of the rollers, the rubber is usually cross-linked by vulcanization and thereby receives the desired durability, while elastic thermoplastics, thermoplastic elastomers and castable and/or foamable plastics attain their durability by cooling from the melt.

### EXAMPLES

The invention is illustrated in the following by examples, without being limited to these.

a) Pan Roller or Fountain Roller

The roller comprises a roller core from plastic as well as a detachable roller cover on basis of polyurethane. The roller core in one embodiment (A) consists of a fiber-reinforced engineering plastic and in another embodiment (B) of a tube of CRP which is filled out with a thermoplastic. The roller has the following dimensions:

| | | | |
|---|---|---|---|
| Overall length: | 596 nun | Covering length: | 513 mm |
| Overall diameter: | 45.5 mm | Core diameter: | 25 mm |

The base of the roller core (A) at its lateral surface comprises bar-like raises with a height of approx. 5 to 7 mm whose edges are rounded off in radial and axial direction. The base of the roller core (B) comprises groove-like recesses with a depth from approx. 5 to 7 mm whose edges are rounded off, in radial and axial direction at its lateral surface. The bases of the roller cores (A) and (B) are formed conical to one side, wherein the conical angle is of 15 minutes. The roller covers are made without reinforcement or carrier body. They however have the same cone angle at their cover inner surface as the roller cores, whereby the inside diameter of the roller covers is smaller 0.8 millimeters than the outside diameter of the roller cores. Aditionally, recesses and/or raises are formed in the covering material at the cover inner surface which correspond with the appropriate raises and/or recesses at the lateral surface of the roller bases. For making the rollers ready for operation the particular roller cover is pushed onto the matching roller core (A) or (B) until the respective raises and recesses mesh into one another. After wear of the roller covers these are removed mechanically from the roller core and replaced by new ones. The worn out roller covers can be disposed directly.

b) Transfer Roller

The roller comprises an essentially cylindrical roller core from steel as well as a detachable roller cover on basis of NBR. The base of the roller core has a beveled face with openings as well as openings at its lateral surface. These openings are connected to a channel inside the roller core, such that the roller core can be subjected with compressed air from the inside. The roller has the following dimensions:

| | | | |
|---|---|---|---|
| Overall length: | 1087 mm | Covering length: | 1035 mm |
| Overall diameter: | 72 mm | Core diameter: | 52 mm |

The roller cover comprises a multi-layer structure, wherein the layer surrounding the inside diameter is reinforced with a fleece from polyamide fibers. To a certain extent this layer forms a flexible reinforcement of the cover inner surface of the roller cover, which is also shaped cylindrically whereat the inside diameter of the roller cover is somewhat smaller than the outside diameter of the roller core. For the assembly or disassembly of the roller cover the roller core is subjected with compressed air, whereby an air layer forms at the surface of the roller base on which the roller cover is shifted.

c) Oscillating Ink Distributor Roller

The roller comprises a slightly conical roller core from steel as well as a detachable roller cover on basis of EPDM. The roller core consists of a tubular base in whose faces roller bearings are placed. Additionally, the base contains a part of the mechanism that causes the oscillating movement of the roller. The base of the roller core is conical to one side, whereat the conical angle amounts to 30 minutes. At the side of the smaller diameter the base comprises a beveled face with openings. This face consists of a plastic with good sliding and friction properties. Further openings are provided on the lateral surface of the roller base. The roller core can be subjected with compressed air from the inside. The roller has the following dimensions:

| | | | |
|---|---|---|---|
| Overall length: | 1071 mm | Covering length: | 1035 mm |
| Overall diameter: | 60 mm | Core diameter: | 34 mm |

The roller cover consists of a carrier body from thermoplastic or thermosetting fiber-reinforced composite material of from approx. 2 to 3 mm thickness and a two-layered covering. The carrier body is shaped conical according to the roller core and at its larger radius comprises structured forms, which mesh with corresponding recesses at the roller base when the tube is put onto it. To avoid losses of compressed air, the faces of the roller core or the roller bearings there present can be provided with a device for locking or sealing.

d) Form Roller

The roller comprises an essentially cylindrical roller core from steel as well as a detachable roller cover on basis of NBR. The base of the roller core is constructed that way that its diameter is variable. The roller has the following dimensions:

| | | | |
|---|---|---|---|
| Overall length: | 596 mm | Covering length: | 576 mm |
| Overall diameter: | 49 mm | Core diameter: | 23/25 mm |

The roller cover consists of an equally cylindrical carrier body from a long-glass-fiber reinforced thermoplastic of from approx. 2 to 5 mm thickness as well as of a single-layer covering on basis of NBR. The base of the roller core being variable in the diameter has at least two adjustable diameters. For the assembly and disassembly of the roller the base is set to the smaller diameter whereby the roller cover becomes freely movable. Optionally the diameter of the roller base can also be adjusted gradually or continuously to several settings. In this way it is possible to use roller covers of different inside diameters in a certain range.

The above-mentioned examples primarily illustrate the manifold variability of the printing roller according to the invention. From this and further knowing the mechanical parameters (e.g. static and dynamic load of the roller), the medium getting into contact with the roller (ink, dampening solution, ink-dampening solution-emulsion, varnish, if necessary also lubricants or cleaning agents etc.) and the desired function of the printing roller in the ink unit, dampening unit or varnishing unit, which are to be considered in a special application, the expert in the art can easily derive the suitable construction of the printing roller for each case, in particular the selection of the covering material. While the selection of the roller core, e.g. with or without means for subjection with compressed air and/or with constant or variable diameter, represents a question of costs in many cases rather, the selection of the construction of the roller covers with or without carrier bodies or reinforcement as well as the intended connecting mechanism between roller core and roller cover depends more on the mechanical loads. The higher the mechanical load is the more rigid and stable in shape the layer at the inside diameter of the roller cover must be.

Favorably, the roller cover of the roller according to the invention is designed that way that it assures a perfect use during the usual service life of the covering, but, after wear of the covering, can be exchanged by a new roller cover easily and deposited. It is further favorable, if the rollers present in the same ink, dampening or varnishing unit have the same technical construction and/or identical core diameters. Thus, the roller covers can be exchanged or selected depending upon their proposed application, and fewer rollers, i.e. roller covers, can be held at stock in the printhouse.

What is claimed is:

1. A roller with a rigid roller core and a roller cover connected detachable with this, characterized in that the roller cover comprises an outside layer of an elastomeric or elastic plastic material and that the roller itself is a printing roller, in particular an ink roller, dampening roller or varnishing roller for a web-fed offset printing machine or a sheet-fed offset printing machine.

2. A process of use of a roller with a rigid roller core and a roller cover connected detachable with this having an outside layer from elastomeric or elastic plastic material as printing roller, in particular as ink roller, dampening roller or varnishing roller in a web-fed offset printing machine or a sheet-fed offset printing machine.

3. A roller according to claim 1 or 2, wherein the roller core comprises a base and associated therewith devices for the admission of the roller in the printing machine, characterized in that the base is optionally shaped tubular or as a solid body and consists of one or more layers which optionally alike or different to each other are from a metallic material, ceramic material, polymer-bound mineral casting or a plastic material, whereat the respective material optionally comprises reinforcement materials, in particular in the form of fibers.

4. A roller according to one of the claims 1 to 3, characterized in that the lateral surface of the roller core and/or its base, and/or the roller cover at its cover inner surface and/or at least one of its front surfaces, comprises one or more recesses and/or raises, whereby optionally raises and/or recesses at the cover inner surface of the roller cover correspond with recesses and/or raises implemented at the roller core or base.

5. A roller according to one of the claims 1 to 4, characterized in that the roller core and/or the roller cover comprise one or more electromagnetic devices.

6. A roller according to one of the claims 1 to 5, characterized in that the diameter of the roller core or of the base is variable.

7. A roller according to one of the claims 1 to 6, characterized in that the roller cover consists optionally of a non-reinforced covering, a—particularly within the range of its inside diameter—reinforced covering or of a carrier body provided with a covering, whereat both the covering and the carrier body are optionally constructed single-layered or multi-layered.

8. A roller according to claim 7, characterized in that the carrier body consists of one or more layers, which in each case optionally are from a metallic, a ceramic or a plastic material, whereat the respective material optionally comprises reinforcing materials, in particular in the form of fibers.

9. A roller according to one of the claims 1 to 8, characterized in that after wear of the roller cover this is removed from the roller core, replaced by another roller cover and supplied to a disposal or a recycling process.

10. A roller according to one of the claims 1 to 9, characterized in that the roller core is provided with a device which permits to install and dismantle the roller cover, alternatively inside or outside of the printing machine, under mechanical effect or by using compressed air.

11. An inking unit, dampening unit or varnishing unit of a printing machine, in particular of a web-fed or a sheet-fed offset printing machine, characterized in that it comprises at least one printing roller in accordance with one of the claims 1 to 10.

12. A process for exchanging the roller cover of a printing roller with a rigid roller core and a roller cover with an outside layer from elastomeric or elastic plastic material in particular an ink roller, dampening roller or varnishing roller in a web-fed offset printing machine or a sheet-fed offset printing machine, characterized in that the roller cover is connected with the roller core detachable.
